(19) United States
(12) Patent Application Publication
(10) Pub. No.: US 2023/0252953 A1
(43) Pub. Date: Aug. 10, 2023

(54) METHOD AND SYSTEM FOR PLACING ONE OR MORE ELEMENTS OVER A MEDIA ARTIFACT

(71) Applicant: INFOSYS LIMITED, Bangalore (IN)

(72) Inventor: Bobin Johnson VIJAYAKUMARI, Kanyakumari District (IN)

(21) Appl. No.: 17/701,914

(22) Filed: Mar. 23, 2022

(30) Foreign Application Priority Data
Feb. 7, 2022 (IN) 202241006330

(51) Int. Cl. G09G 5/00; H04L 65/60

(52) U.S. Cl. CPC G09G 5/003; H04L 65/604; G09G 2340/0442; G09G 2340/0407

(57) ABSTRACT

Provided is a method and system for placing one or more elements over a media artifact by identifying an adjustment requirement of the media artifact on a device, identifying a placeholder for each of the one or more elements on the media artifact, checking a position of the placeholder in an initial device; and identifying a relative position for the placeholder for each element, on the media artifact at a distance from the appropriate margins of the device based on the identified adjustment requirement and the checked position.

This application claims the benefit of Indian Patent Application Serial No. 202241006330, filed Feb. 7, 2022, which is hereby incorporated by reference in its entirety.

### FIELD

The present disclosure relates to placing one or more elements on a media artifact. More specifically it relates to placing an element on the media artifact at the same spot while rendering it on different devices.

### BACKGROUND

The present trend is towards increasing the amount of image information shown on physical and virtual displays of smaller and smaller size, such as handheld devices, cell phones, browser windows and thumbnails. Such a display of image information requires reformatting of the originally stored images. Current methods use cascading style sheets to target specific resolutions or range to place element over an image or video. This will be different for rendering the image or video on different devices, and will be dependent on the resolution.

### SUMMARY

Provided is an example of the process for placing one or more elements over a media artifact rendering on a device, comprising identifying an adjustment requirement of the media artifact on the device, identifying a placeholder for each of the one or more elements on the media artifact, checking a position of the placeholder in an initial device; and identifying a relative position for the placeholder for each element, on the media artifact at a distance from the appropriate margins of the device based on the identified adjustment requirement and the checked position.

Provided is a system for placing one or more elements over a media artifact rendering on a device comprising a processor and a memory comprising instructions executable by the processor to cause the system to perform operations comprising identifying an adjustment requirement of the media artifact on the device; identifying a placeholder for each of the one or more elements on the media artifact, checking a position of the placeholder in an initial device; and identifying a relative position for the placeholder for each element, on the media artifact at a distance from the appropriate margins of the device based on the identified adjustment requirement and the checked position.

Provided is a non-transitory computer-readable storage medium storing computer-executable instructions that when executed cause a computing system to perform a method comprising, identifying an adjustment requirement of the media artifact on the device, identifying a placeholder for each of the one or more elements on the media artifact, checking a position of the placeholder in an initial device; and identifying a relative position for the placeholder for each element, on the media artifact at a distance from the appropriate margins of the device based on the identified adjustment requirement and the checked position.

### BRIEF DESCRIPTION

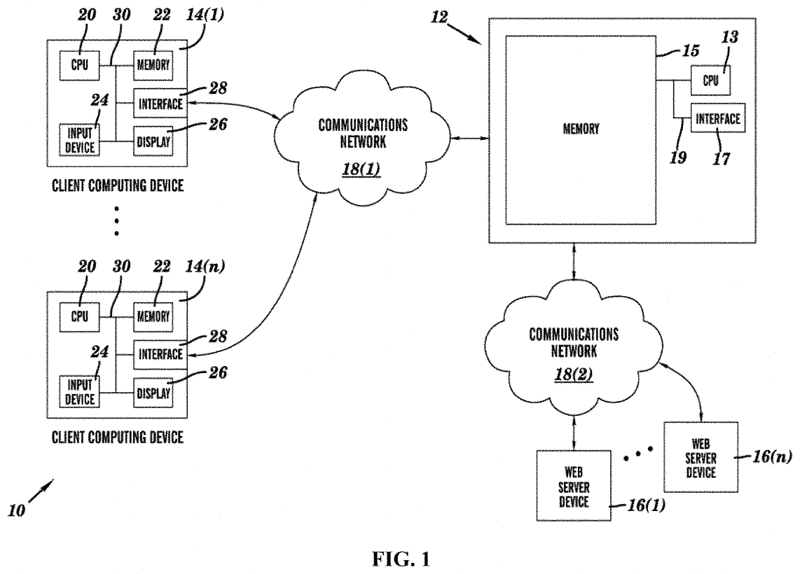

FIG. 1 relates to a general-purpose computing system to implement an example of the process as disclosed;

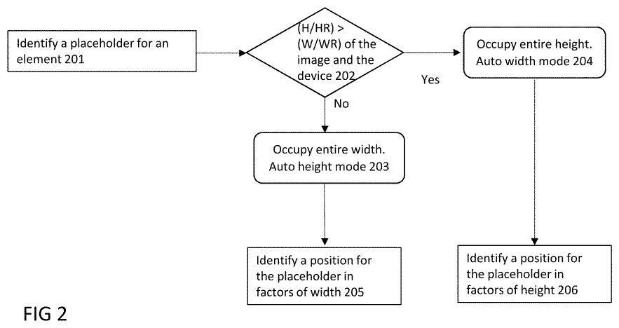

FIG. 2 relates to a flowchart for an example of the process as disclosed;

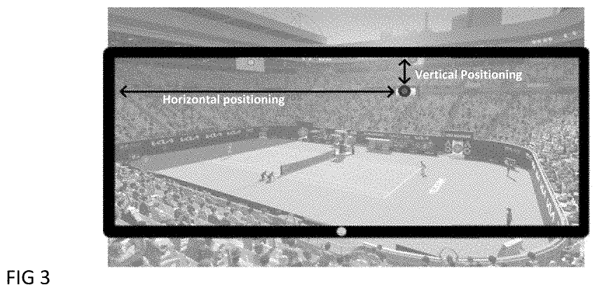

FIG. 3 discloses a sample image for describing the present disclosure; and

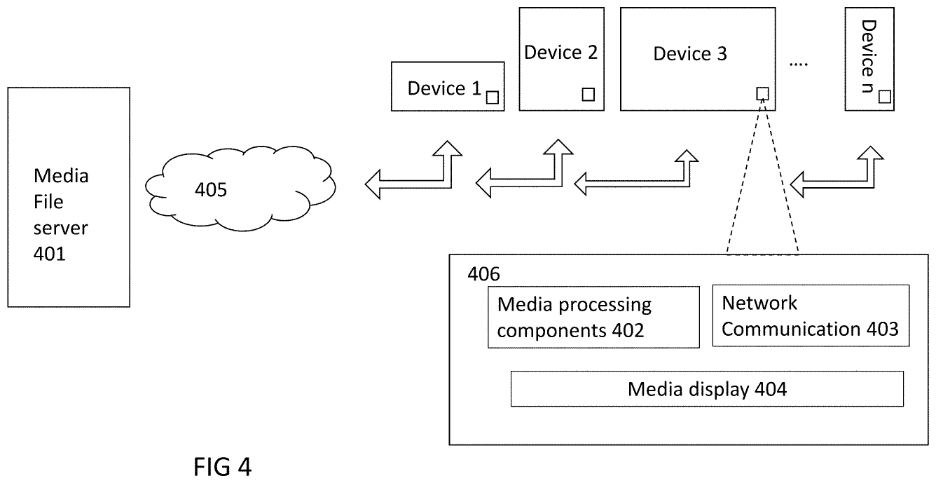

FIG. 4 relates to an example of the system for implementing the present disclosure.

### DETAILED DESCRIPTION

In an example, the present disclosure relates to placing elements over an image or video or any media file so that the elements don't change position when the same media is rendered in different devices/resolutions. The media file may be rendered in a way so there is no scroll or black borders in the webpage. This may be done by using the aspect ratio of the image along with the device resolution. The media file may also be a live streaming file.

For the purpose of this document, Auto Height mode for rendering a media file may imply that the width of the image always takes 100% of the width of any device and the height is the factor which various across devices. So, we can say width measure is a constant and height measure is a variable.

Auto Width mode may imply that height is a constant measure across various devices taking 100% and width is a factor which varies.

Viewport width VW, and Viewport height VH are CSS measurement units, and indicates the device/browser window. For instance, hence 100 vw indicates the image should take 100% the width of the device/browser window.

An exemplary environment 10 with a rendering system 12 configured to render media artifacts and place elements, is illustrated in FIG. 1, although this technology can be implemented on other types of devices, such as one of the web server devices 16(1)-16(n), or any other server computing apparatus configured to receive and process hypertext transfer protocol (HTTP) requests, by way of example only. The exemplary environment 10 includes a rendering system 12, client devices 14(1)-14(n), the web server devices 16(1)-16(n), and communication networks 18(1)-18(2), although other numbers and types of systems, devices, and/or elements in other configurations and environments with other communication network topologies can be used. This technology provides several advantages including providing a method, computer readable medium and an apparatus that can provide image rendering.

Referring more specifically to FIG. 1, the rendering system 12 may include a central processing unit (CPU) or processor 13, a memory 15, and an interface system 17 which are coupled together by a bus 19 or other link, although other numbers and types of components, parts, devices, systems, and elements in other configurations and locations can be used. The processor 13 in the rendering system 12 executes a program of stored instructions for one or more aspects of the present disclosure as described and illustrated by way of the examples herein, although the processor could execute other numbers and types of programmed instructions.

The memory 15 in the rendering system 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the web content optimization computing apparatus 12.

The interface system 17 in the rendering system 12 is used to operatively couple and communicate between the rendering system 12 and the client devices 14(1)-14(n) and the web server devices 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client devices 14(1)-14(n) enables a user to request, receive, and interact with web pages from one or more web sites hosted by the web server devices 16(1)-16(n) through the rendering system 12 via one or more communication networks 18(1). Although multiple client devices 14(1)-14(n) are shown, other numbers and types of user computing systems could be used. In one example, the client devices 14(1)-14(n) comprise smart phones, personal digital assistants, computers, or mobile devices with Internet access that permit a website form page or other retrieved web content to be displayed on the client devices 14(1)-14(n).

Each of the client devices 14(1)-14(n) in this example is a computing device that includes a central processing unit (CPU) or processor 20, a memory 22, user input device 24, a display 26, and an interface system 28, which are coupled together by a bus 30 or other link, although one or more of the client devices 14(1)-14(n) can include other numbers and types of components, parts, devices, systems, and elements in other configurations. The processor 20 in each of the client devices 14(1)-14(n) executes a program of stored instructions for one or more aspects of the present invention as described and illustrated herein, although the processor could execute other numbers and types of programmed instructions.

The memory 22 in each of the client devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client devices 14(1)-14(n).

The user input device 24 in each of the client devices 14(1)-14(n) is used to input selections, such as requests for a particular website form page or to enter data in fields of a form page, although the user input device could be used to input other types of data and interact with other elements. The user input device can include keypads, touch screens, and/or vocal input processing systems, although other types and numbers of user input devices can be used.

The display 26 in each of the client devices 14(1)-14(n) is used to show data and information to the user, such as website or application page by way of example only. The display in each of the client devices 14(1)-14(n) can be a mobile phone screen display, although other types and numbers of displays could be used depending on the particular type of client device 14(1)-14(n).

The interface system 28 in each of the client devices 14(1)-14(n) is used to operatively couple and communicate between the client devices 14(1)-14(n), the rendering system 12, and the web server devices 16(1)-16(n) over the communication networks 18(1) and 18(2), although other types and numbers of communication networks with other types and numbers of connections and configurations can be used.

The web server devices 16(1)-16(n) provide web content such as one or more pages from one or more web sites for use by one or more of the client devices 14(1)-14(n) via the rendering system 12, although the web server devices 16(1)-16(n) can provide other numbers and types of applications and/or content and can provide other numbers and types of functions. Although the web server devices 16(1)-16(n) are shown for ease of illustration and discussion, other numbers and types of web server systems and devices can be used.

Each of the web server devices 16(1)-16(n) include a central processing unit (CPU) or processor, a memory, and an interface system which are coupled together by a bus or other link, although each of the web server devices 16(1)-16(n) could have other numbers and types of components, parts, devices, systems, and elements in other configurations and locations. The processor in each of the web server devices 16(1)-16(n) executes a program of stored instructions one or more aspects of the present invention as described and illustrated by way of the examples herein, although the processor could execute other numbers and types of programmed instructions.

The memory in each of the web server devices 16(1)-16(n) stores these programmed instructions for one or more aspects of the present invention as described and illustrated by way of the examples described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the web server devices 16(1)-16(n).

The interface system in each of the web server devices 16(1)-16(n) is used to operatively couple and communicate between the web server devices 16(1)-16(n), the rendering system 12, and the client devices 14(1)-14(n) via the communication networks 18(1) and 18(2), although other types and numbers of communication networks with other types and numbers of connections and configurations can be used.

Although examples of the rendering system 12, the client devices 14(1)-14(n), and the web server devices 16(1)-16(n), are described and illustrated herein, each of the client devices 14(1)-14(n), the rendering system 12, and the web server devices 16(1)-16(n), can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any of the examples. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present invention as described and illustrated by way of the examples herein, as described herein, which when executed by a processor, cause the processor to carry out the steps necessary to implement the methods of the examples, as described and illustrated herein.

An example of the process to implement the present technology will now be explained along with the description of FIG. 2. In an example, when a media file has to be rendered on another device initially the elements to be placed on the media file may be identified. The elements may be used by the user for clicking and getting further details or options. These elements may be graphics, any icon, any menu button, or any other appropriate option as per the user requirement. For instance, a live sports video can have clickable buttons on the score board to show further details. The score board can be rendered at different positions on different devices. As per the present technology, the element will be placed on the scoreboard on every device. In every device the element may look like a part of media file itself In an example, the element may also be placed using an overlay process. A user may use any other process to place the elements on a media file.

In an example, once a user decides the elements that need to be placed on the media file, the user may decide a placeholder for the elements (201). A placeholder may be any position in the image where the user may want to have an element for accessing further options. In the example mentioned in the previous paragraph about live tennis streaming, the score board may be the place holder. In another instance, a position in the spectators may be a placeholder.

In an example, the adjustment required in the media file for rendering may be identified (202). In one example, the aspect ratio of the image and device browser resolution may be used for optimal rendering of the media file. A ratio of height of the device to height factor of the aspect ratio maybe compared with the ratio of width of the device to the width factor of the aspect ratio. When the ratio of height of the device to height factor of the aspect ratio is greater than ratio of width of the device to the width factor of the aspect ratio, then height may need to be adjusted, and width of the device is used 100%; and when it is lesser the width may need to be adjusted and height maybe used 100% (203, 204).

For the purpose of this document, when the ratio of height to height factor of the aspect ratio is greater, it may be referred as auto width mode, and the media file is rendered in auto width mode. When the ratio of height to height factor of the aspect ratio is lesser, it may be referred as auto height mode.

In an example, in auto height mode the media file may take the full width of the browser window and there may be some manipulation of content in the height of the image. 100 vw may indicate that the media file may take 100% the width of the device or browser window.

In an example, once a placeholder is decided its position in one of the devices maybe checked where the media file can be accessed. Using that, the position of the placeholder in the rendered media file is identified using the position of the element in terms of the static dimension. For identifying the position of placeholder in auto height mode (205), the horizontal position of the placeholder maybe taken as some distance x from the left or right margin, or it may be measured in percentage of the width since width is constant in auto height mode. In one example, the vertical positioning maybe calculated in factors of width. In an example, initially the location corresponding to 50 vh may be located. 50 vh may indicate the location of exact half of the height of the window irrespective of the device. Then from 50 vh, the required location may be calculated using the position of the placeholder checked earlier in one of the devices.

For instance, please refer FIG. 3. This is an auto height mode image rendering. The placeholder is the score board. The horizontal positioning of the placeholder, i.e., the scoreboard may be 70% of the width. The vertical positioning of the scoreboard maybe, 50 vh-20 vw.

The vertical position maybe calculated in terms of width (20 vw) as width is a constant measure here and doesn't change across devices. 20 vw maybe the figure checked from the position of the placeholder in an earlier device.

In an example, once the position of the placeholder for the element is identified, the element can then be placed over it, using any appropriate technique for instance overlay, CSS etc. Similarly, the position of all placeholders for the elements required on a media file are identified for the device wherever the media file will be rendered, in auto height mode.

In an example, in auto width mode, the media file may take the full height of the device or browser window and there may be some loss of content in the width of the image. 100 vh may indicate that the image should take 100% the height of the device/browser window. The height is a constant measure across various devices and width is a factor which varies. Accordingly, the position of placeholder maybe calculated. The vertical position of the placeholder can be some distance from top/bottom margin, or some percentage of the whole height. The horizontal positioning can be calculated by first identifying 50 vw as exact half of the width of the window irrespective of the device. The exact position may then be calculated by measuring from 50 vw. This may be measured using the position of the placeholder identified initially in another device.

For instance, in auto width mode, the position of the placeholder
left: (50 vw−10 vh)
top: 30%

An example of a system to implement the present process will now be explained along with the description of FIG. 4. For the purpose of this document, a media rendering server (401) may be considered having some media files which may be required to be rendered to multiple devices (device 1 . . . device n), or it may be a live streaming from a venue.

Device 1 to device n maybe connected to the rendering server through a network. Or it may be through a cloud service. Each of the device may have a media rendering system (406) which may comprise components as appropriate, configured to identify and place the required elements as described in the process above.

In an example the media rendering system (406) may have a network communication component (403). The network communication component may be configured to receive and send data as needed, using general networking methods and protocols. The device 1—device n may receive the position of the placeholder or the configurations related to the element using the network communication component (403). In another example, the media artifact rendering and the element positioning as explained earlier, is downloaded along with the web page as a bundle and rendered in browser. The media processing component (402) may be configured to identify the auto height mode or the auto width mode and the adjustment and processing needs in the media file. The media processing component may also be configured to calculate and identify the positions of placeholder of the elements as described earlier.

In an example the media display component (404) may display the rendered media file and place the elements on the media file as identified and calculated by the media processing component. The device may have components configured to place the elements on the media file as per the position identified. It may use an overlay technology, HTML and CSS , or any other appropriate technology to place the element.

The device 1—device n, may be any computing machine, or any handheld device configured to receive communications and comprising display components.

In an example, the media processing component maybe an internet browser which may render the media artifact. The media artifact can also be a web pages built on HTML/CSS/JS. The web page maybe downloaded as a bundle of code containing the algorithm for rendering the media artifact and positioning the elements downloaded from the media file server. The element positioning process maybe developed along with the webpage.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for placing one or more elements over a media artifact rendering on a device, comprising:
identifying an adjustment requirement of the media artifact, on the device;
identifying a placeholder for each of the one or more elements on the media artifact;
checking a position of the placeholder in an initial device; and
identifying a relative position for the placeholder for each element, on the media artifact at a distance from the appropriate margins of the device based on the identified adjustment requirement and the checked position.

2. The method as claimed in claim 1, wherein the identifying the adjustment requirement comprises:
comparing a ratio of height of the device to height factor of the aspect ratio, with the ratio of width of the device to the width factor of the aspect ratio; and
identifying height as the adjustment required if the ratio of height of the device to height factor of the aspect ratio is greater; and
identifying width as the adjustment required if the ratio of width of the device to width factor of the aspect ratio is greater.

3. The method as claimed in claim 2, wherein when the height is identified as the required adjustment, the media artifact fits full width of the device.

4. The method as claimed in claim 2, wherein when the width is identified as the required adjustment, the media artifact fits full height of the device.

5. The method as claimed in claim 1, wherein the identifying a relative position for the placeholder comprises:
identifying the position of the placeholder from the left or right margin of the device in factors of height, when width of the media artifact is the identified adjustment requirement;
identifying the position from the top or bottom margin of the device in factors of width, when height of the media artifact is the identified adjustment requirement; and
wherein the factors of height, and factors of width is identified from the position of the placeholder in the initial device.

6. A system for placing one or more elements over a media artifact rendering on a device comprising a processor and a memory comprising instructions executable by the processor to cause the system to perform operations comprising:
identifying an adjustment requirement of the media artifact, on the device;
identifying a placeholder for each of the one or more elements on the media artifact;
checking a position of the placeholder in an initial device; and
identifying a relative position for the placeholder for each element, on the media artifact at a distance from the appropriate margins of the device based on the identified adjustment requirement and the checked position.

7. The system as claimed in claim 6, wherein identifying the adjustment requirement comprises:
comparing a ratio of height of the device to height factor of the aspect ratio, with the ratio of width of the device to the width factor of the aspect ratio;
identifying height as the adjustment required if the ratio of height of the device to height factor of the aspect ratio is greater; and
identifying width as the adjustment required if the ratio of width of the device to width factor of the aspect ratio is greater.

8. The system as claimed in claim 7, wherein when the height is identified as the required adjustment, the media artifact fits full width of the device.

9. The system as claimed in claim 7, wherein when the width is identified as the required adjustment, the media artifact fits full height of the device.

10. The system as claimed in claim 6, wherein the identifying a relative position for the placeholder comprises:
identifying the position of the placeholder from the left or right margin of the device in factors of height, when width of the media artifact is the identified adjustment requirement;
identifying the position from the top or bottom margin of the device in factors of width, when height of the media artifact is the identified adjustment requirement; and
wherein the factors of height, and factors of width is identified from the position of the placeholder in the initial device.

11. A system for placing one or more elements over a media artifact rendering on a device comprising a processor and a memory comprising instructions executable by the processor to cause the system to perform operations comprising:
identifying an adjustment requirement of the media artifact, on the device;
identifying a placeholder for each of the one or more elements on the media artifact;
checking a position of the placeholder in an initial device; and
identifying a relative position for the placeholder for each element, on the media artifact at a distance from the appropriate margins of the device based on the identified adjustment requirement and the checked position.

12. The system as claimed in claim 6, wherein identifying the adjustment requirement comprises:
comparing a ratio of height of the device to height factor of the aspect ratio, with the ratio of width of the device to the width factor of the aspect ratio;
identifying height as the adjustment required if the ratio of height of the device to height factor of the aspect ratio is greater; and
identifying width as the adjustment required if the ratio of width of the device to width factor of the aspect ratio is greater.

13. The system as claimed in claim 7, wherein when the height is identified as the required adjustment, the media artifact fits full width of the device.

14. The system as claimed in claim 7, wherein when the width is identified as the required adjustment, the media artifact fits full height of the device.

15. The system as claimed in claim 6, wherein identifying a relative position for the placeholder comprises:
identifying the position of the placeholder from the left or right margin of the device in factors of height, when width of the media artifact is the identified adjustment requirement;
identifying the position from the top or bottom margin of the device in factors of width, when height of the media artifact is the identified adjustment requirement; and
wherein the factors of height, and factors of width is identified from the position of the placeholder in the initial device.

16. A computer program product comprising a computer-readable storage media having computer-executable instructions stored thereupon, which when executed by a processor cause the processor to perform a method for placing one or more elements over a media artifact rendering on a device, comprising:
identifying an adjustment requirement of the media artifact, on the device;
identifying a placeholder for each of the one or more elements on the media artifact;
checking a position of the placeholder in an initial device; and
identifying a relative position for the placeholder for each element, on the media artifact at a distance from the appropriate margins of the device based on the identified adjustment requirement and the checked position.

17. The computer program product as claimed in claim 16, wherein identifying the adjustment requirement comprises:
comparing a ratio of height of the device to height factor of the aspect ratio, with the ratio of width of the device to the width factor of the aspect ratio;
identifying height as the adjustment required if the ratio of height of the device to height factor of the aspect ratio is greater; and
identifying width as the adjustment required if the ratio of width of the device to width factor of the aspect ratio is greater.

18. The computer program product as claimed in claim 17, wherein when the height is identified as the required adjustment, the media artifact fits full width of the device.

19. The computer program product as claimed in claim 17, wherein when the width is identified as the required adjustment, the media artifact fits full height of the device.

20. The computer program product as claimed in claim 16, wherein identifying a relative position for the placeholder comprises:
identifying the position of the placeholder from the left or right margin of the device in factors of height, when width of the media artifact is the identified adjustment requirement;
identifying the position from the top or bottom margin of the device in factors of width, when height of the media artifact is the identified adjustment requirement; and
wherein the factors of height, and factors of width is identified from the position of the placeholder in the initial device.
